(19) United States
(12) Patent Application Publication
(10) Pub. No.: US 2016/0165228 A1
(43) Pub. Date: Jun. 9, 2016

(54) DISPLAY APPARATUS AND CONTROLLING METHOD THEREOF

(71) Applicant: SAMSUNG ELECTRONICS CO., LTD., Suwon-si (KR)

(72) Inventor: Soo-hong KIM, Seoul (KR)

(21) Appl. No.: 14/837,799

(22) Filed: Aug. 27, 2015

(30) Foreign Application Priority Data
Dec. 4, 2014 (KR) 10-2014-0173393

(51) Int. Cl. H04N 17/00; H04N 5/44; H04N 21/4363; G09G 5/00

(52) U.S. Cl. CPC H04N 17/004; G09G 5/006; H04N 5/4403; H04N 21/43632; G09G 2370/12; G09G 2370/06

(57) ABSTRACT

A display apparatus is provided. The display apparatus includes a first communicator or communication circuitry configured to perform network communication with a server which provides a remote diagnosis service, a second communicator or communication circuitry configured to be connected to an external electronic apparatus via High Definition Multimedia Interface (HDMI) to perform communication, and a processor configured to, in response to receiving a control command regarding a remote diagnosis service of the external electronic apparatus from the server, convert the received control command to a Consumer Electronics Control (CEC) command to control an operation of the external electronic apparatus, and transmit operation state information of the external electronic apparatus to the server.

### CROSS-REFERENCE TO RELATED APPLICATIONS

This application is based on and claims priority under 35 U.S.C. §119 to Korean Patent Application No. 10-2014-0173393, filed in the Korean Intellectual Property Office on Dec. 4, 2014, the disclosure of which is incorporated herein by reference in its entirety.

### BACKGROUND

1. Field

Aspects of the example embodiments relate to a display apparatus and a controlling method thereof, and for example, to a display apparatus which controls an external electronic apparatus by performing communication with a server and the external electronic apparatus and a controlling method thereof.

2. Description of the Related Art

With the development of electronic technologies, various types of electronic products have been developed and distributed, and electronic apparatuses having various communication functions have been widely used in general households. In addition, a function not only for controlling an electronic product directly using a communication function but also for controlling another electronic product connected to the electronic product indirectly has been introduced.

In particular, electronic apparatuses which are connected via High Definition Multimedia Interface (HDMI) may be inter-controllable by changing a control command to a Consumer Electronics Control (CEC) command. Accordingly, another electronic apparatus connected to a display apparatus via HDMI may be controlled using a remote controller, etc.

However, another electronic apparatus can be controlled only when the remote controller is at close range, and cannot be controlled if the electronic apparatus is at a distance. Thus, if there is a problem in another electronic apparatus, a user needs to personally visit a repair shop, which causes inconvenience.

### SUMMARY

An aspect of the example embodiments relates to a display apparatus which controls an external electronic apparatus connected to a display apparatus through a server, and a controlling method thereof.

According to an example embodiment, a display apparatus is provided including a first communication circuit or circuitry configured to perform network communication with a server which provides a remote diagnosis service, a second communication circuit or circuitry configured to be connected to an external electronic apparatus via, for example, High Definition Multimedia Interface (HDMI) to perform communication, and a processor configured to receive a control command regarding a remote diagnosis service of the external electronic apparatus from the server, convert the received control command to a Consumer Electronics Control (CEC) command to control an operation of the external electronic apparatus, and transmit operation state information of the external electronic apparatus to the server.

The processor may also be configured to convert a state request signal according to the received control command to a CEC command, transmit the CEC command to the external electronic apparatus, reverse received operation state information according to the state request signal, and transmit the operation state information to the server.

The processor may also be configured to control an operation of the external electronic apparatus according to the received control command, obtain operation state information of the display apparatus according to the operation of the external electronic apparatus, and transmit the operation state information to the server.

The processor may also be configured to, in response to receiving a control command regarding a screen diagnosis service of the external electronic apparatus from the server, may convert the received control command to a CEC command to control an operation of the external electronic apparatus, and transmit screen state information of the display apparatus according to the operation of the external electronic apparatus.

The processor may also be configured to, in response to receiving a control command regarding a connection diagnosis service of the external electronic apparatus from the server, may convert the received control command to a CEC command to control an operation of the external electronic apparatus, and transmit connection state information of the display apparatus according to the operation of the external electronic apparatus to the server.

The processor may also be configured to, in response to receiving a diagnosis result according to an operation state of the external electronic apparatus from the server, may directly control the external electronic apparatus based on the received diagnosis result.

The diagnosis result may, for example, be information indicating a software error of the external electronic apparatus, and the processor may receive information for initializing or updating software of the external electronic apparatus, provide the information to the external electronic apparatus, and control the external electronic apparatus to perform the initialization or update.

The diagnosis result may be information indicating that the external electronic apparatus is normal, and the processor may transmit operation state information of the display apparatus to the server.

The apparatus may further include storage configured to store a CEC command conversion table, and the processor may convert the control command to a CEC command based on information stored in the storage.

The apparatus may further include a display, and the processor may be configured to control the display to display operation state information of the external electronic apparatus.

According to an example embodiment, a method for controlling a display apparatus is provided including performing network communication with a server which provides a remote diagnosis service and receiving a control command regarding a remote diagnosis service of the external electronic apparatus connected via HDMI from the server, converting the received control command to a CEC command, controlling an operation of the external electronic apparatus with the CEC command and transmitting operation state information of the external electronic apparatus to the server.

Transmitting may include, for example, converting a state request signal according to the received control command to a CEC command, transmitting the CEC command to the external electronic apparatus, reversing received operation state information according to the state request signal, and transmitting the operation state information to the server.

The method may further include controlling an operation of the external electronic apparatus according to the received control command, obtaining operation state information of the display apparatus according to the operation of the external electronic apparatus, and transmitting the operation state information to the server.

The control command regarding a remote diagnosis service of the external electronic apparatus may be a control command regarding a screen diagnosis service of the external electronic apparatus, and transmitting may include transmitting screen state information of the display apparatus according to the operation of the external electronic apparatus to the server.

The control command regarding a remote diagnosis service of the external electronic apparatus may be a control command regarding a connection diagnosis service of the external apparatus, and transmitting may include transmitting connection state information of the display apparatus according to the operation of the external electronic apparatus to the server.

The method may further include, in response to receiving a diagnosis result according to an operation state of the external electronic apparatus from the server, directly controlling the external electronic apparatus based on the received diagnosis result.

The diagnosis result may be information indicating a software error of the external electronic apparatus, and directly controlling may include receiving information for initializing or updating software of the external electronic apparatus, providing the information to the external electronic apparatus, and controlling the external electronic apparatus to perform the initialization or update.

The diagnosis result may be information indicating that the external electronic apparatus is normal, and directly controlling may include transmitting operation state information of the display apparatus to the server.

Converting to a CEC command may include converting the control command to a CEC command based on a CEC command conversion table.

The method may further include displaying operation state information of the external electronic apparatus.

According to the above-described various example embodiments, a display apparatus may receive a control command from a server to control an external electronic apparatus connected to the display apparatus, thereby improving user convenience.

### BRIEF DESCRIPTION OF THE DRAWINGS

The above and/or other aspects and advantages of the example embodiments will become more apparent from the following detailed description taken in conjunction with the accompanying drawings, in which like reference numerals refer to like elements, and wherein:

FIG. 1 is a view illustrating a remote diagnosis system according to an example embodiment;

FIGS. 2A-2B are block diagrams illustrating configurations of a display apparatus according to example embodiments;

FIGS. 3A-3B are views provided to explain a remote diagnosis service according to various example embodiments;

FIG. 4 is a flowchart provided to explain an operation of a display apparatus after receiving a diagnosis result from a server according to an example embodiment;

FIGS. 5A-5C are views provided to explain various example CEC command conversion tables according to example embodiments; and

FIG. 6 is a flowchart provided to explain a method for controlling a display apparatus according to an example embodiment.

### DETAILED DESCRIPTION

The example embodiments may be diversely modified. Accordingly, example embodiments are illustrated in the drawings and are described in detail in the detailed description. However, it is to be understood that the disclosure is not limited to any particular example embodiment, but includes all modifications, equivalents, and substitutions without departing from the scope and spirit of the disclosure. Also, well-known functions or constructions are not described in detail since they would obscure the disclosure with unnecessary detail.

Hereinafter, example embodiments will be described in greater detail with reference to the accompanying drawings.

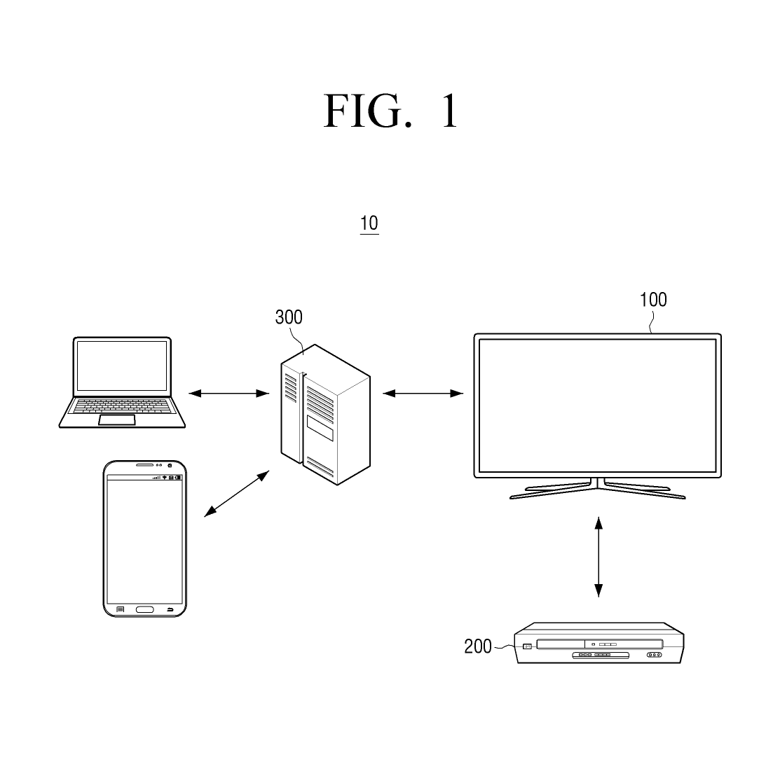

FIG. 1 is a view illustrating a remote diagnosis system 10 according to an example embodiment. As illustrated in FIG. 1, the remote diagnosis system 10 includes a display apparatus 100, an external electronic apparatus 200 and a server 300.

The display apparatus 100 may perform network communication with the server 300 which provides a remote diagnosis service. In particular, the display apparatus 100 may receive a user's control command remotely by performing network communication with the server 300. For example, a user may control the display apparatus 100 through the server 300 using a notebook computer or a mobile phone. However, this is only an example, and a user may also control the display apparatus 100 using for example a desktop computer or a tablet PC, or the like. FIG. 1 illustrates that the server 300 is an apparatus which connects a user and the display apparatus 100, but the user's notebook computer or mobile phone may be directly connected to the display apparatus 100 and control the display apparatus 100 without the server 300. However, in this example, it is assumed that the remote diagnosis system 10 is connected to the server 300.

The display apparatus 100 may be connected to an external electronic apparatus 200 via a High Definition Multimedia Interface (HDMI) and perform communication with the external electronic apparatus. HDMI is one of the interface standards for integrated transmission of uncompressed digital video and an audio signals. HDMI is a standard which converts DVI, a interface standard specification of PC and display, to a standard for AV home appliances so that video and audio can be transmitted from a player to a TV without compression. In addition, apparatuses which are connected via HDMI may be controlled through a Consumer Electronics Control (CEC) command.

If a control command regarding a remote diagnosis service of the external electronic apparatus 200 is received from the server 300, the display apparatus 100 may convert the received control command to a CEC command to control an operation of the external electronic apparatus 200, and transmit operation state information of the external electronic apparatus 200 to the server 300. In this case, a control command regarding a remote diagnosis service may be transmitted in various forms. For example, a control command may be transmitted using an Internet network or a communication network of a mobile phone, etc. Meanwhile, the display apparatus 100 may control the external electronic apparatus 200, receive operation state information from the external electronic apparatus 200 or directly determine the operation state information, and transmit the state information to the server 300.

Meanwhile, the external electronic apparatus 200 may be connected to the display apparatus 100 via HDMI and receive a control command from the display apparatus 100. In addition, the external electronic apparatus 200 may transmit operation state information, etc. to the display apparatus 100 via HDMI.

The external electronic apparatus 200 may be, for example, a broadcast receiving apparatus such as a set-top box, but is not limited thereto. For example, the external electronic apparatus 200 may be any external electronic apparatus which may operate in association with a display apparatus, such as, for example, a DVD player, etc.

Meanwhile, the server 300 may perform network communication with the display apparatus 100 to provide a remote diagnosis service. For example, the server 300 may perform network communication with a plurality of display apparatuses to provide a remote diagnosis service. In this case, the server 300 may, for example, encrypt and store information regarding each user of a plurality of display apparatuses, and the server 300 may, for example, provide the function for controlling only the display apparatus 100 corresponding to each user.

The above-described remote diagnosis system 10 allows a user to control the external electronic apparatus 200 connected to the display apparatus 100 remotely or to determine operation state information so that the user may use the external electronic apparatus 200 more conveniently.

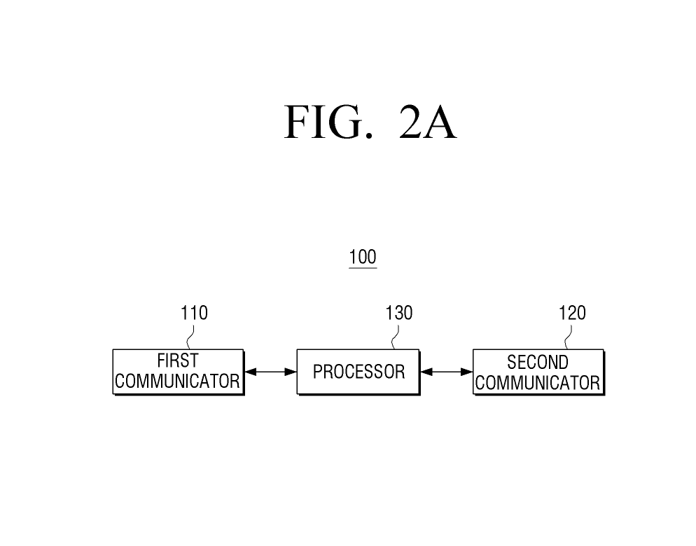

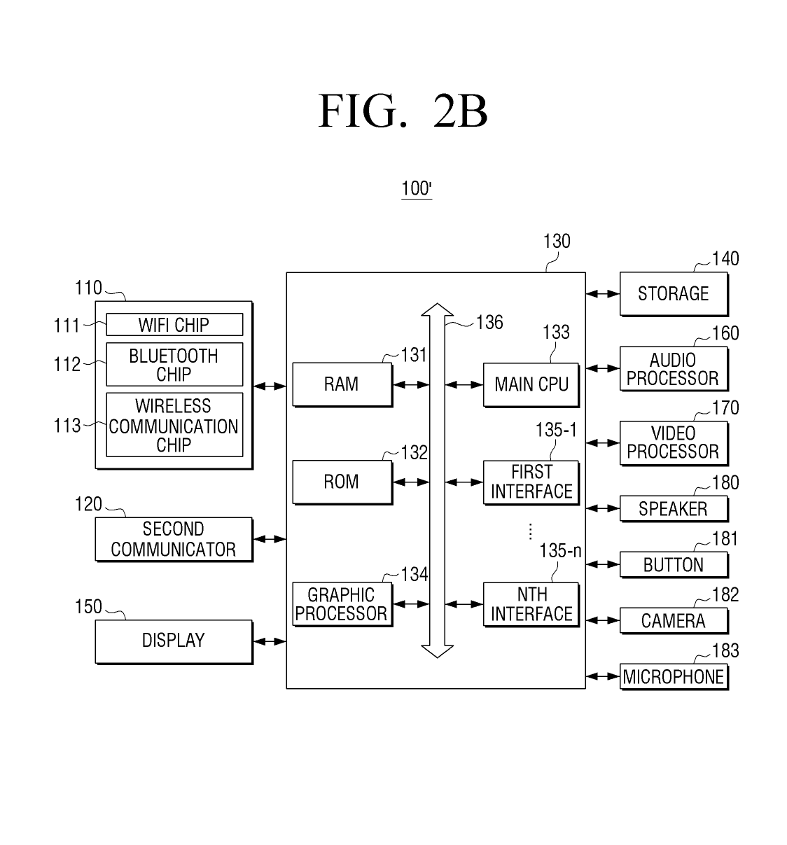

Hereinafter, the display apparatus 100 will be described in greater detail with reference to FIGS. 2 to 5.

FIG. 2A is a block diagram illustrating an example configuration of the display apparatus 100 according to an example embodiment. As illustrated in FIG. 2A, the display apparatus 100 includes a first communicator or communication circuit 110, a second communicator or communication circuit 120 and a processor 130.

The first communicator 110 may, for example, be configured to communicate with the server 300. The first communicator 110 may receive a control command regarding a remote diagnosis service of the external electronic apparatus 200 from the server, and transmit operation state information of the external electronic apparatus 200 to the server 300. To do so, the first communicator 110 may, for example, include various communication cards and/or modules such as wired Local Area Network (LAN) card, wireless LAN card, Bluetooth module, Near Field Communication (NFC) module, wireless communication module, etc. In this case, the wireless communication module refers to a module, e.g., circuitry, which performs communication according to communication standards such as IEEE, Zigbee, 3rd Generation (3G), 3rd Generation Partnership Project (3GPP), Long Term Evolution (LTE), or the like.

The second communicator 120 may, for example, be configured to communicate with the external electronic apparatus 200 which is connected to the display apparatus 100 via HDMI. For example, the second communicator 120 may transmit or receive a CEC command to or from the external electronic apparatus 200. The CEC command may, for example, be a control command to control the external electronic apparatus 200, but is not limited thereto. For example, the CEC command may be environment setting information provided to an external apparatus or operation state information from an external electronic apparatus, which will be described in detail below.

The processor 130 may, for example, be configured to control overall operations of the server 100.

The processor 130 may, for example, be an element for controlling an apparatus, and may be used together with a Central Processing Unit (CPU), a microprocessor, a processor, etc. The processor 130 is configured to control overall operations of an apparatus, and may, for example, be realized as a System-on-a-chip (System on chip, SOC, SoC) along with another function unit such as the communicator 120.

If a control command regarding a remote diagnosis service of the external electronic apparatus 200 is received from the server 300, the processor 130 may, for example, be configured to convert the received control command to a CEC command to control an operation of the external electronic apparatus 200, and transmit operation state information of the external electronic apparatus 200 to the server 300.

In addition, the processor 130 may, for example, be configured to convert a state request signal according to the received control command to a CEC command, transmit the CEC command to the external electronic apparatus 200, and reverse the operation state information received according to the state request signal, and transmit the information to the server 300.

The processor 130 may, for example, be configured to control an operation of the external electronic apparatus according to the received control command, obtain operation state information of the display apparatus according to the operation of the external electronic apparatus 200, and transmit the information to the server 300.

In addition, if a control command regarding a screen diagnosis service of the external electronic apparatus 200 is received from the server 300, the processor 130 may, for example, be configured to convert the received control command to a CEC command to control an operation of the external electronic apparatus 200, and transmit screen state information of the display apparatus 100 according to the operation of the external electronic apparatus 200, and transmit the information to the server 300.

Further, if a control command regarding a screen diagnosis service of the external electronic apparatus 200 is received from the server 300, the processor 130 may, for example, be configured to convert the received control command to a CEC command to control an operation of the external electronic apparatus, and transmit screen state information of the display apparatus 100 according to the operation of the external electronic apparatus 200 to the server 300.

If a control command regarding a connection diagnosis service of the external electronic apparatus 200 is received from the server 300, the processor 130 may, for example, be configured to convert the received control command to a CEC command to control an operation of the external electronic apparatus 200, and transmit connection state information of the display apparatus 100 according to the operation of the external electronic apparatus 200 to the server 300.

In addition, if a diagnosis result according to the operation state of the external electronic apparatus 200 is received from the server 300, the processor 130 may, for example, be configured to directly control the external electronic apparatus 200 based on the received diagnosis result.

The diagnosis result may, for example, be information on errors of software of the external electronic apparatus 200, and the processor 130 may be configured to receive information for initializing or updating software of the external electronic apparatus 200 and provide the information to the external electronic apparatus 200 in order to control the electronic apparatus to proceed with initialization or update.

In addition, the diagnosis result may, for example, be information indicating that the external electronic apparatus 200 is normal, and the processor 130 may, for example, be configured to transmit operation state information of the display apparatus 100 to the server 300.

A storage which stores a CEC command conversion table may be further included, and the processor 130 may, for example, be configured to convert a control command to a CEC command based on information stored in the storage, such as, for example, a command conversion table.

In addition, a display may be further included, and the processor 130 may, for example, be configured to control the display to display operation state information of the external electronic apparatus 200.

FIG. 2B is a block diagram illustrating detailed configuration of a display apparatus 100′ according to another example embodiment. Referring to FIG. 2B, the display apparatus 100′ includes the first communicator or communication circuitry 110, the second communicator or communication circuitry 120, the processor 130, a storage 140, a display 150, an audio processor 160, a video processor 170, a speaker 180, a button 181, a camera 182, and a microphone 183. The detailed descriptions regarding the elements which are overlapped with the elements illustrated in FIG. 2A among the elements of FIG. 2B will not be provided.

The processor 130 may, for example, be configured to control overall operations of the display apparatus 100 using various programs stored in the storage 140.

Specifically, the processor 130 may, for example, include a RAM 131, a ROM 132, a main CPU 133, a graphic processor 134, first to nth interface 135-1˜135-n, and a bus 136.

The RAM 131, the ROM 132, the main CPU 133, the graphic processor 134, the first to the nth interface 135-1˜135-n, etc. may, for example, be interconnected through the bus 136.

The first to the nth interface (135-1 to 135-n) are connected to the above-described various elements. One of the interfaces may, for example, be a network interface which is connected to an external apparatus via network.

The main CPU 133 may, for example, access the storage 140, and perform booting using an Operating System (O/S) stored in the storage 140. In addition, the main CPU 133 may, for example, perform various operations using various programs stored in the storage 140.

The ROM 132 may, for example, store a set of commands for system booting. If a turn-on command is input and thus, power is supplied, the main CPU 133 may, for example, copy the O/S stored in the storage 140 in the RAM 131 according to a command stored in the ROM 132, and boots a system by executing the O/S. When the booting is completed, the main CPU 133 copies various application programs stored in the storage 150 in the RAM 131, and executes the application programs copied in the RAM 131 to perform various operations.

The graphic processor 134 may, for example, generate a screen including various objects such as an icon, an image, a text, etc. using an computing unit (not shown) and a rendering unit (not shown). The computing unit computes property values such as coordinates, shape, size, and color of each object to be displayed according to the layout of the screen using a control command received from an input unit. The rendering unit generates a screen with various layouts including objects based on the property values computed by the computing unit. The screen generated by the rendering unit is displayed in a display area of the display 150.

Meanwhile, the operations of the above-described controller 130 may be performed by a program stored in the storage 140.

The storage 140 stores, for example, various data such as Operating System (O/S) software module to drive the display apparatus 100, CEC command conversion table, control module of the external electronic apparatus 200 according to a diagnosis result, etc.

In this case, the processor 130 may, for example, be configured to display operation state information of the external electronic apparatus 200 based on information stored in the storage 140.

The audio processor 160 performs processing with respect to audio data. The audio processor 160 may, for example, perform various processing such as decoding, amplification, noise filtering, etc. with respect to audio data.

The video processor 170 performs processing with respect to video data. The video processor 170 may, for example, perform various image processing such as decoding, scaling, noise filtering, frame rate conversion, resolution conversion, etc. with respect to video data.

The speaker 180 outputs not only various audio data processed by the audio processor 160 but also various alarm sounds or voice messages, etc.

The button 181 may be realized as various types of buttons such as a mechanical button, a touch pad, a wheel, etc. which may, for example, be formed on the front, side, or rear of the exterior of a main body.

The camera 182 may photograph a still image or a moving image according to a user's control. The camera 182 may be realized as a plurality of cameras such as a front camera, a rear camera, etc. The microphone 183 receives a user voice or other sounds and converts the same into audio data.

Hereinafter, a basic configuration and various example embodiments will be described.

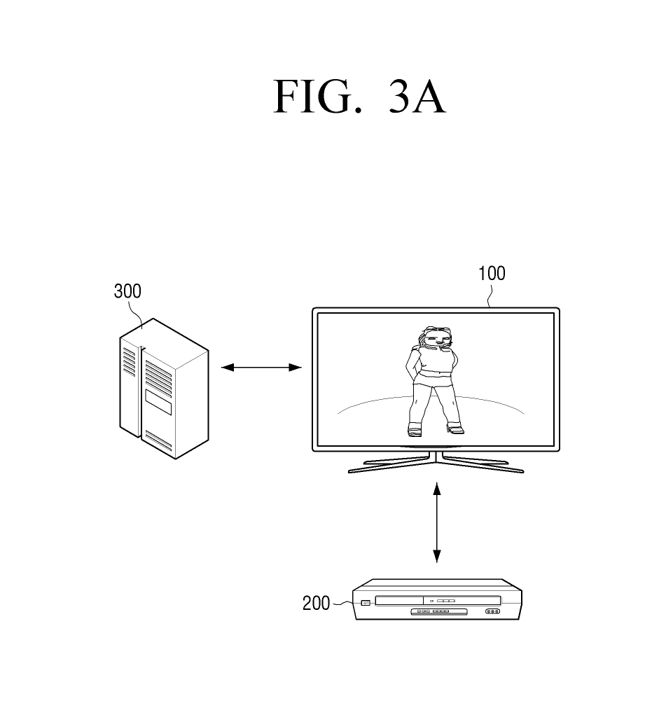

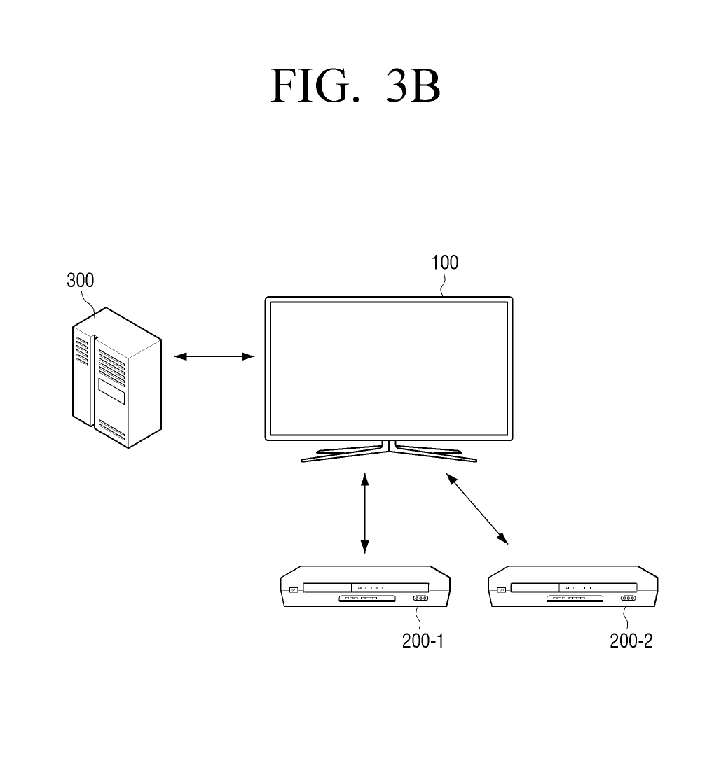

FIGS. 3A-3B are views provided to explain a remote diagnosis service according to various example embodiments.

FIG. 3A is a view provided to explain a remote screen diagnosis service according to an example embodiment. Referring to FIG. 3A, the processor 130 may, for example, be configured to receive a control command regarding a screen diagnosis service of the external electronic apparatus 200 from the server 300. If there is a problem on a display screen while a user is watching a specific content using the display apparatus 100 and it is impossible to fix the problem, the user may request help from a service center, and the service center may directly transmit a control command to the display apparatus 100 using a screen diagnosis service through the server from outside. However, this is only an example, and the user may directly use a screen diagnosis service through the server 300 from outside. According to various examples, it is assumed that a service center provides a diagnosis service from outside for convenience of explanation.

The control command may be a command to request information regarding a content provided from the external electronic apparatus 200, a command to receive a content again, etc. As described above, the control command may be a command to control a detailed operation of the external electronic apparatus 200 directly, but is not limited thereto. For example, the control command may be a command for the display apparatus 100 to diagnose the external electronic apparatus 200 directly, or a command for the external electronic apparatus 200 to self-diagnose directly and transmit the diagnosis result.

Meanwhile, the processor 130 may, for example, be configured to convert the received control command to a CEC command. The processor 130 may, for example, be configured to control an operation of the external electronic apparatus 200 by transmitting the CEC command to the external electronic apparatus 200, and transmit screen state information of the display apparatus 100 according to the operation of the external electronic apparatus 200 to the server 300. In this case, the processor 130 may be configured not only to transmit the screen state information of the display apparatus 100 but also to receive operation state information from the external electronic apparatus 200 and transmit the information to the server 300. Here, for example, the operation state information received from the external electronic apparatus 200 may also be received as a CEC command, and the processor 130 may, for example, be configured to reverse the operation state information in the form of a CEC command and transmit the CEC command to the server 300. In addition, the processor 130 may, for example, be configured to transmit not only the screen state information of the display apparatus 100 but to also transmit the operation state information of the display apparatus 100 to the server 300.

FIG. 3A illustrates, for example, that the resolution provided by the display apparatus 100 is not consistent with the resolution of a content received from the external electronic apparatus 200 and thus, the content is enlarged and displayed in a horizontal direction. For example, if the screen ratio of content provided by the external electronic apparatus 200 is 4:3 while the screen ratio provided by the display apparatus 100 is 16:10. Accordingly, a control command for screen diagnosis may be received from the server 300.

If, for example, the control command is to request information regarding the content provided by the external electronic apparatus 200, a service center may receive the content information, determine that there is a problem in the resolution, and transmit a new control command to adjust the screen ratio.

If, for example, the control command is to request adjustment of the screen automatically, the display apparatus 100 may determine that the resolution of the display apparatus 100 is not consistent with the resolution of the content according to the control command and adjust the screen ratio. Alternatively, the external electronic apparatus 200 may determine the inconsistency of the resolution, change the resolution of the content, and transmit the same to the display apparatus 100.

FIG. 3B is a view provided to explain an example remote connection diagnosis service according to another example embodiment. Referring to FIG. 3B, if a control command regarding a connection diagnosis service of the external electronic apparatus 200 is received from the server 300, the processor 130 may, for example, be configured to convert the received control command to a CEC command to control an operation of the external electronic apparatus 200, and transmit connection state information of the display apparatus 100 to the server 300.

FIG. 3B illustrates that a plurality of external electronic apparatuses 200-1, 200-2 may be connected. If a user wishes to watch a content of the first external electronic apparatus 200-1, but a content of the second external electronic apparatus 200-2 is displayed or no content is displayed, a service center may transmit a control command and provide a connection diagnosis service.

A service center may transmit a control command to request information from the plurality of external electronic apparatuses 200-1, 200-2 regarding whether they are providing content to the display apparatus 100. If there is no response, or information that no content is being provided is received, the service center may transmit a power supply command to the corresponding external electronic apparatus, or transmit a control command to receive and provide a content.

Alternatively, the control command may, for example, be a command for the display apparatus 100 to determine a connection state and adjust the connection state automatically. For example, the display apparatus 100 may determine a connection state of the plurality of external electronic apparatuses 200-1, 200-2 and if it is determined that any one of the plurality of external electronic apparatuses is not connected, may display and notify the state to a user. If it is determined that all of the plurality of external electronic apparatuses 200-1, 200-2 are connected, the display apparatus 100 may display and notify the user of the name of an external electronic apparatus which is providing the content which is currently displayed.

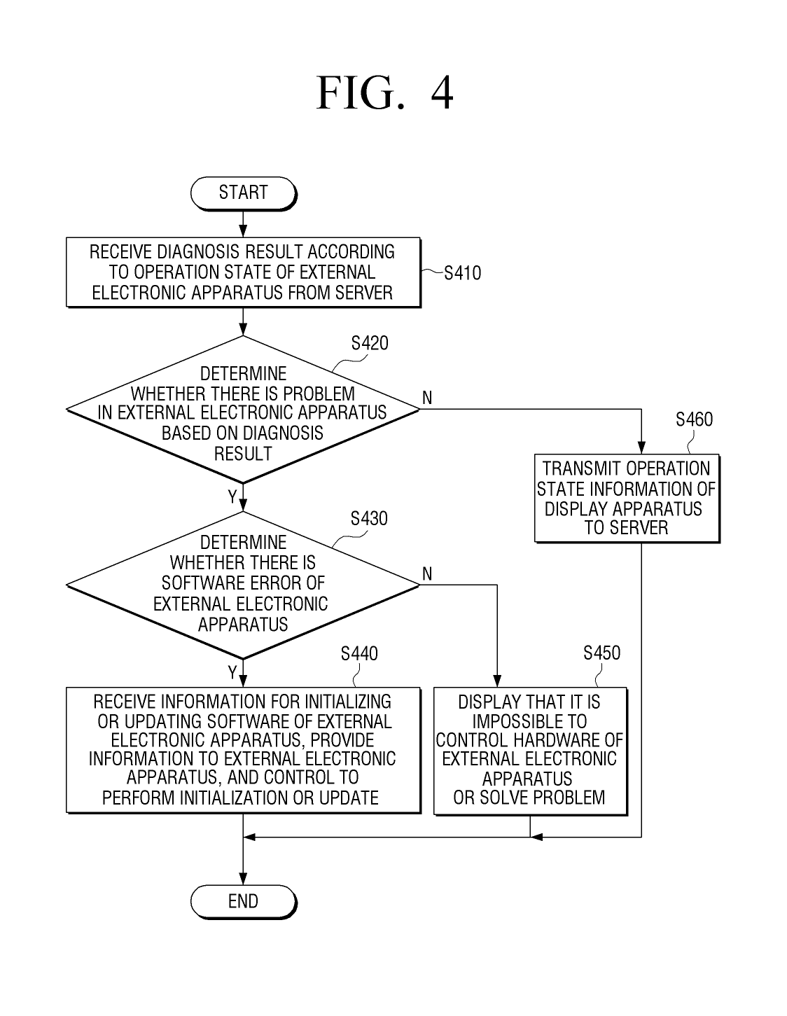

FIG. 4 is a flowchart provided to explain an example operation of the display apparatus 100 after receiving a diagnosis result from the server 300 according to an example embodiment. For example, the display apparatus 100 receives a control command from the server 300 and transmits operation state information of the corresponding external electronic apparatus 200 and operation state information of the display apparatus 100 to the server 300. The server 300 which receives the operation state information may directly generate a diagnosis result thereof, or may transmit the operation state information to a service center and receive a diagnosis result.

Referring to FIG. 4, the processor 130 may, for example, be configured to receive a diagnosis result according to the operation state of the external electronic apparatus 200 from the server (S410). Subsequently, the processor 130 determines whether there is a problem of the external electronic apparatus 200 based on the diagnosis result (S420). Here, the diagnosis result received from the server 300 may be information directly determined whether it is a problem of the external electronic apparatus 200 and in this case, the processor 130 analyzes corresponding information and performs a corresponding operation.

If it is determined that it is a problem of the external electronic apparatus 200, the processor 130 determines whether it is a software error of the external electronic apparatus 200 (S430). If it is determined that it is a software error of the external electronic apparatus 200, the processor 130 may receive information for initialization or update of the software of the external electronic apparatus 200 and provide the information to the external electronic apparatus 200 so that initialization or update may be performed (S440). If it is determined that it is not a software error of the external electronic apparatus 200, the processor 130 may display that it is impossible to control hardware of external electronic apparatus or solve problem (S450).

Meanwhile, if it is determined that it is not a problem of the external electronic apparatus 200 based on the diagnosis result, the processor 130 transmits operation state information of the display apparatus 100 to the server (S460). The server 300 may diagnosis the display apparatus 100 based on the received operation state information of the display apparatus 100, and transmit the diagnosis result or an appropriate control command to the display apparatus 100.

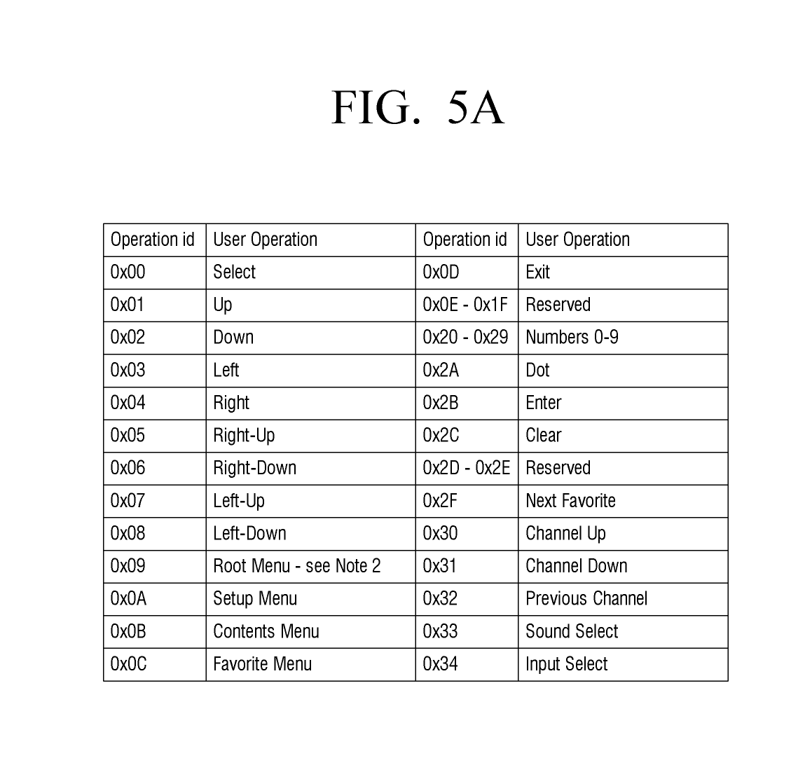

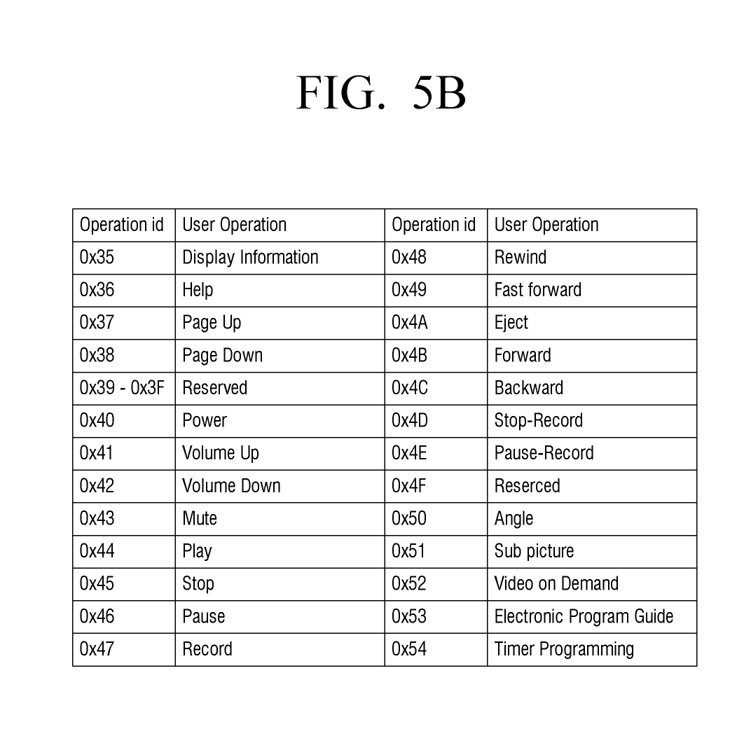

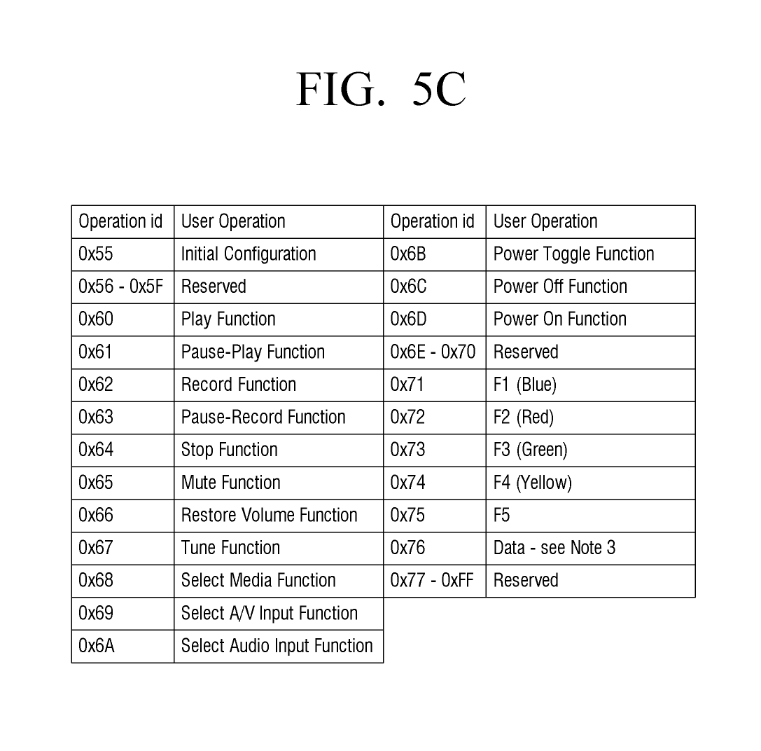

FIGS. 5A-5C are views provided to explain a CEC command conversion table according to example embodiments.

Referring to FIGS. 5A to 5C, the display apparatus 100 further includes a storage 140 which may, for example, store a CEC command conversion table, and the processor 130 may, for example, be configured to convert a control command to a CEC command based on information stored in the storage 140. The CEC command conversion table generally includes control commands, but may include an operation ID for transmitting data.

In addition, if there is an operation ID where a user operation is not allocated in a CEC command conversion table, a manufacturer, for example, may allocate a desired function to the above operation ID. For example, a manufacturer may allocate its own function to the operation ID and use the function. However, this is only an example, and a manufacturer may not allocate any function to the operation ID where a user operation is not allocated, or may allocate a command function through an agreement, etc. with other manufacturers.

As described above, the display apparatus 100 may receive a control command from the server 300 and control the external electronic apparatus 200 connected to the display apparatus, thereby improving user convenience.

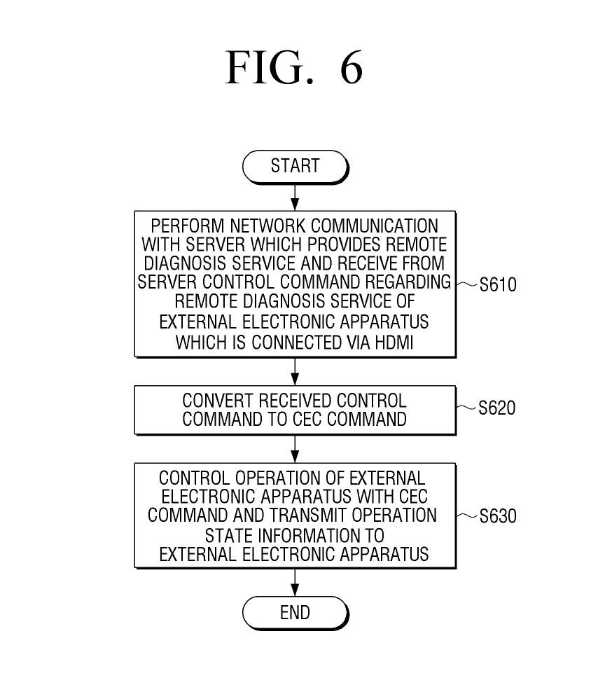

FIG. 6 is a flowchart provided to explain an example method for controlling the display apparatus 100 according to an example embodiment.

Referring to FIG. 6, the display apparatus 100 receives a control command regarding a remote diagnosis service of the external electronic apparatus 200 connected via HDMI from the server 300 via network communication with the server 300 which provides a remote diagnosis service.

The display apparatus 100 converts the received control command to a CEC command (S620). Subsequently, the display apparatus 100 controls an operation of the external electronic apparatus 200 with the CEC command and transmits operation state information of the external electronic apparatus 200 to the server (S630).

In addition, the step (S630) of transmitting the operation state information to the server 300 may include converting a state request signal according to the received control command to a CEC command, transmitting the CEC command to the external electronic apparatus 200, reversing the received operation state information according to the state request signal, and transmitting the operation state information to the server 300.

In addition, the step of controlling an operation of the external electronic apparatus 200 according to the received control command, obtaining operation state information of the display apparatus 100 according to the operation of the external electronic apparatus 200 and transmitting the same to the server 300 may be further included.

Further, the control command regarding a remote diagnosis service of the external electronic apparatus 200 may be a control command regarding a screen diagnosis service of the external electronic apparatus 200, and the step (S630) of transmitting the operation state information to the server 300 may include transmitting screen state information of the display apparatus 100 according to the operation of the external electronic apparatus 200 to the server 300.

The control command regarding a remote diagnosis service of the external electronic apparatus 200 may be a control command regarding a connection diagnosis service of the external electronic apparatus 200, and the step (S630) of transmitting the operation state information to the server 300 may include transmitting connection state information of the display apparatus 100 according to the operation of the external electronic apparatus 200 to the server 300.

If a diagnosis result according to the operation state of the external electronic apparatus 200 is received from the server 300, the external electronic apparatus 200 may be directly controlled based on the received diagnosis result may be further included.

The diagnosis result is information indicating a software error of the external electronic apparatus 200, and the step of directly controlling may include receiving information for initializing or updating the software of the external electronic apparatus 200, providing the information to the external electronic apparatus 200, and performing the initialization or update.

In addition, the diagnosis result may be information indicating that the external electronic apparatus 200 is normal, and the step of directly controlling may include transmitting the operation state information of the display apparatus 100 to the server 300.

The step (S620) of converting the received control command to a CEC command may include converting a control command to a CEC command based on a CEC command conversion table.

In addition, the step of displaying the operation state information of the external electronic apparatus 200 may be further included.

According to the above-described various example embodiments, the display apparatus 100 may receive a control command from the server 300 and control the external electronic apparatus 200 connected to the display apparatus 100 and thus, may improve user convenience.

Meanwhile, the methods according to the above-various embodiments may be programmed and stored in various storage media. Accordingly, the methods according to the various example embodiments may be realized in various types of electronic apparatuses which execute the above the storage media. For example, as described above, and will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

For example, according to an example embodiment, a non-transitory computer readable medium storing a program which performs receiving a control command regarding a remote diagnosis service of an external electronic apparatus connected via HDMI from a server by performing network communication with the server which performs a remote diagnosis service, converting the received control command to a CEC command, and controlling an operation of the external electronic apparatus with the converted CEC command, and transmitting operation state information of the external electronic apparatus to the server sequentially may be provided.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as CD, DVD, hard disk, Blu-ray disk, USB, memory card, ROM, etc.

The foregoing embodiments and advantages are merely examples and are not to be construed as limiting the disclosure. The present teaching can be readily applied to other types of apparatuses. Also, the description of the example embodiments is intended to be illustrative, and not to limit the scope of the claims, and many alternatives, modifications, and variations will be apparent to those skilled in the art.

What is claimed is:

1. A display apparatus, comprising:
first communications circuitry configured to perform network communication with a server which provides a remote diagnosis service;
second communications circuitry configured to be connected to an external electronic apparatus via High Definition Multimedia Interface (HDMI); and
a processor configured to, in response to receiving a control command regarding a remote diagnosis service of the external electronic apparatus from the server, convert the received control command to a Consumer Electronics Control (CEC) command to control an operation of the external electronic apparatus, and transmit operation state information of the external electronic apparatus to the server.

2. The apparatus as claimed in claim 1, wherein the processor is configured to convert a state request signal according to the received control command to a CEC command, transmit the CEC command to the external electronic apparatus, reverse received operation state information according to the state request signal, and transmit the operation state information to the server.

3. The apparatus as claimed in claim 1, wherein the processor is configured to control an operation of the external electronic apparatus based on the received control command, obtain operation state information of the display apparatus based on the operation of the external electronic apparatus, and transmit the operation state information to the server.

4. The apparatus as claimed in claim 1, wherein the processor, in response to receiving a control command regarding a screen diagnosis service of the external electronic apparatus from the server, is configured to convert the received control command to a CEC command to control an operation of the external electronic apparatus, and transmit screen state information of the display apparatus according to the operation of the external electronic apparatus.

5. The apparatus as claimed in claim 1, wherein the processor, in response to receiving a control command regarding a connection diagnosis service of the external electronic apparatus from the server, is configured to convert the received control command to a CEC command to control an operation of the external electronic apparatus, and transmit connection state information of the display apparatus based on the operation of the external electronic apparatus to the server.

6. The apparatus as claimed in claim 1, wherein the processor, in response to receiving a diagnosis result according to an operation state of the external electronic apparatus from the server, is configured to control the external electronic apparatus based on the received diagnosis result.

7. The apparatus as claimed in claim 6, wherein the diagnosis result is information indicating a software error of the external electronic apparatus,
wherein the processor is configured to receive information for initializing or updating software of the external electronic apparatus, provide the information to the external electronic apparatus, and to control the initialization or update.

8. The apparatus as claimed in claim 6, wherein the diagnosis result is information indicating that the external electronic apparatus is normal, wherein the processor is configured to transmit operation state information of the display apparatus to the server.

9. The apparatus as claimed in claim 1, further comprising:
a storage configured to store a CEC command conversion table,
wherein the processor is configured to convert the control command to a CEC command based on information stored in the storage.

10. The apparatus as claimed in claim 1, further comprising:
a display,
wherein the processor is configured to control the display to display operation state information of the external electronic apparatus.

11. A method of controlling a display apparatus, comprising:
communicating with a server which provides a remote diagnosis service and receiving a control command regarding a remote diagnosis service of the external electronic apparatus connected via HDMI from the server;
converting the received control command to a CEC command; and
controlling an operation of the external electronic apparatus with the CEC command and transmitting operation state information of the external electronic apparatus to the server.

12. The method as claimed in claim 11, wherein transmitting operation state information comprises converting a state request signal based on the received control command to a CEC command, transmitting the CEC command to the external electronic apparatus, reversing received operation state information based on the state request signal, and transmitting the operation state information to the server.

13. The method as claimed in claim 11, further comprising:
controlling an operation of the external electronic apparatus based on the received control command, obtaining operation state information of the display apparatus based on the operation of the external electronic apparatus, and transmitting the operation state information to the server.

14. The method as claimed in claim 11, wherein the control command regarding a remote diagnosis service of the external electronic apparatus is a control command regarding a screen diagnosis service of the external electronic apparatus,
wherein transmitting operation state information comprises transmitting screen state information of the display apparatus based on the operation of the external electronic apparatus to the server.

15. The method as claimed in claim 11, wherein the control command regarding a remote diagnosis service of the external electronic apparatus is a control command regarding a connection diagnosis service of the external apparatus,
wherein transmitting operation state information comprises transmitting connection state information of the display apparatus based on the operation of the external electronic apparatus to the server.

16. The method as claimed in claim 11, further comprising:
directly controlling the external electronic apparatus based on the received diagnosis result in response to receiving a diagnosis result based on an operation state of the external electronic apparatus from the server.

17. The method as claimed in claim 16, wherein the diagnosis result is information indicating a software error of the external electronic apparatus,
wherein directly controlling comprises receiving information for initializing or updating software of the external electronic apparatus, providing the information to the external electronic apparatus, and controlling the external electronic apparatus to perform the initialization or update.

18. The method as claimed in claim 16, wherein the diagnosis result is information indicating that the external electronic apparatus is normal, wherein directly controlling comprises transmitting operation state information of the display apparatus to the server.

19. The method as claimed in claim 11, wherein converting to a CEC command comprises converting the control command to a CEC command based on a CEC command conversion table.

20. The method as claimed in claim 11, further comprising:
displaying operation state information of the external electronic apparatus.
